(19) United States
(12) Patent Application Publication
(10) Pub. No.: US 2009/0223213 A1
(43) Pub. Date: Sep. 10, 2009

(54) EMISSION CONTROL DEVICE

(76) Inventor: Peter Lambe, Orange, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/095,310

(22) PCT Filed: Nov. 13, 2007
(86) PCT No.: PCT/US07/84538

§ 371 Date: Oct. 24, 2008

Related U.S. Application Data
(60) Provisional application No. 60/865,567, filed on Nov. 13, 2006.

(51) Int. Cl. F01N 3/021; F16L 5/02; F16L 21/02

(52) U.S. Cl. 60/311; 277/607; 285/367

(57) ABSTRACT

An improved emission control device as disclosed which is modular in construction and which includes unique and improved mechanical joint connections which obviate the need for costly welding which has been needed in the past. The filter preferably is constructed as a mono-directional unit to avoid the possibility of the filter itself being turned around during supposed maintenance which would result in blowing ash back out into the environment.

### BACKGROUND OF THE INVENTION

The present application is directed to a new and improved diesel particular filter which is modular in construction and with unique and improved mechanical joint connections which obviate the need for costly welding which has been used in the past. Importantly, the filter preferably is constructed as a mono-directional unit so as to avoid maintenance of the filter by just turning the filter around and blowing the ash back out into the environment. The filter includes inlet and outlet modules which allow for additional mounting support if needed. Other unique features will become apparent through a consideration of the following description and drawings.

It thus is a principal feature of the present invention to provide an improved modular canning emission control device.

### BRIEF DESCRIPTION OF THE DRAWINGS

FIG. 1 is a plan view of the present emission control device.

FIG. 2 is a perspective view thereof.

FIGS. 3 and 4 illustrate clamps for the inlet and out modules.

FIGS. 5 through 8 illustrate further details of the mono-directional filtration unit and the unique flow sleeve encompassing an optional bayonet twist lock.

FIGS. 9 and 10 show a mounting support and strap location arrangement.

FIG. 11 illustrates further detail of the mounting tie bar.

FIGS. 12a and 12b illustrate the use of a horizontal pin.

### DESCRIPTION OF THE PREFERRED EMBODIMENT

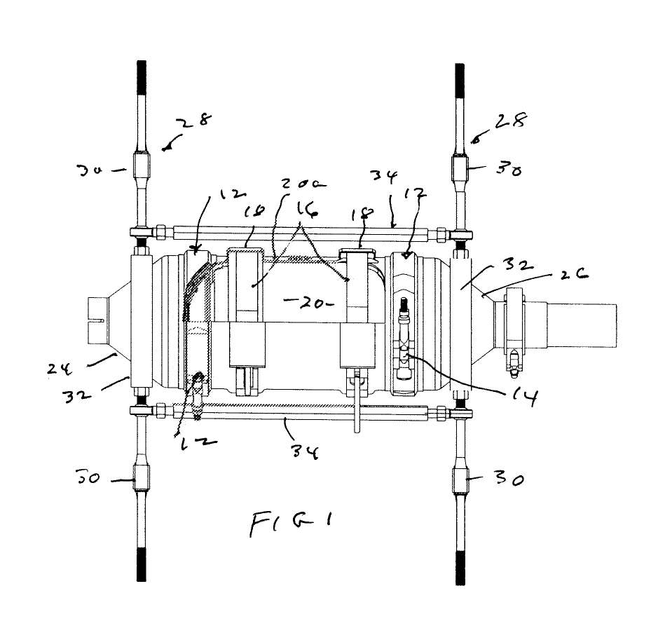

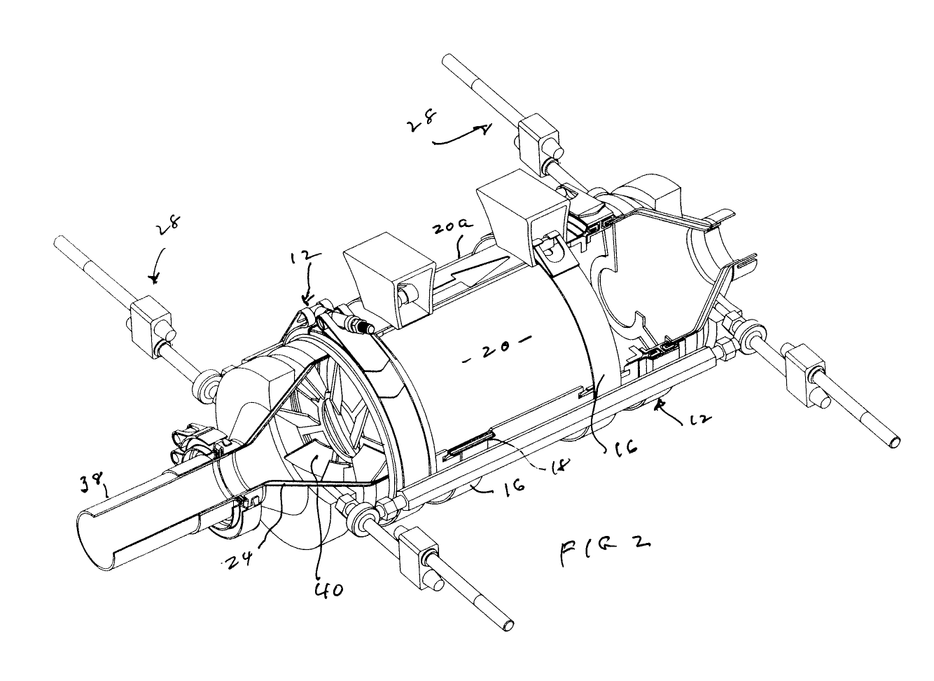

Turning now to the drawings, and first to FIGS. 1 and 2, a plan and a perspective view of the present emission control device and optional mounting system are shown. The filter 20 is shown in cut-away in these Figures, and end straps 16 and strap locators 18 are provided which ensure that installers always use the correct location so as not to jeopardize the mounting of the filter and thereby reducing the risk of the unit dismounting from the vehicle on which it is disposed. These Figures also illustrate clamp 12 design for mounting the inlet module 24 and outlet module 26.

These Figures illustrate an optional mounting system 28 comprising hanging brackets 30, slip rings 32 adjacent the inlet module 24 and outlet module 26. Tie bars 34 appropriately space the end units of the mounting system.

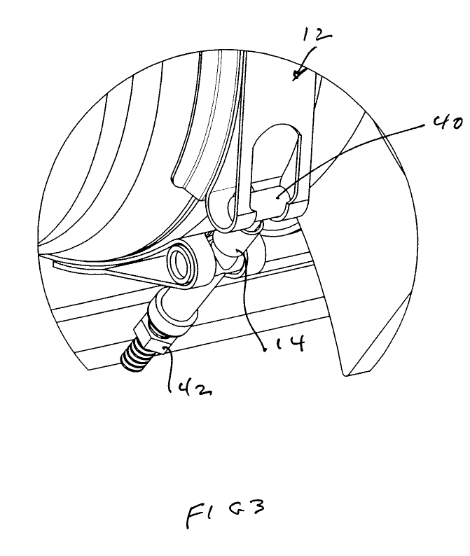

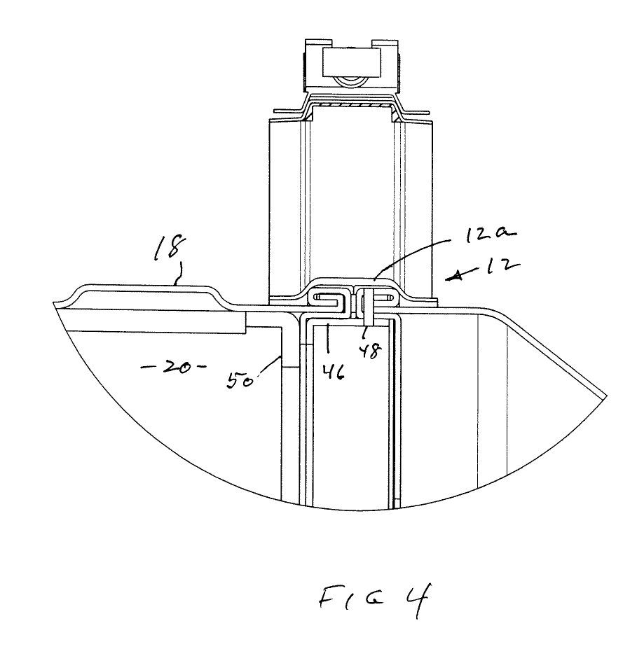

FIG. 2 illustrates the filter housing 20a and further details of the inlet module 24 and outlet module 26 which are conical in shape but could be a different shape. An exhaust feed pipe connector 38 is shown connected to the inlet module 24. A diffuser 40 is disposed within the inlet module 24 to provide mixing and swirling of air. The clamp 12 at the inlet end is shown adjacent the inlet module 24 for securely connecting the inlet module 24 and the inlet of the filter module 20a and which will be described further in connection with FIGS. 3 and 4. Also shown is an anti-vibration strap 16.

Turning now to FIGS. 3 and 4, further details of the clamps 12 for securing the end modules 24, 26 to the filter module 20a are shown in further detail. This assembly can be referred to as a coupling assembly 40. Preferably the clamp design includes a thread stripping nut 42 such that when the clamp is removed, the operator is prevented from reusing the clamp. Importantly, this assembly includes a color sleeve 14 which indicates whether it is the first fit or a subsequent one and what stage of cleaning/maintenance the assembly is in. This protects the manufacture/supplier from warranty issues and ensures that the units are maintained because if they are not, premature failure of the filter unit can occur and possibly may cause damage to the vehicle's engine to which the filter is fitted.

The clamp 12 is widened for greater support and for securely holding end beads discussed below. The clamp includes an inner tongue 12a (FIG. 4) designed to aid the fitting of the adjoining modules, and all corners are radiused to reduce the risk of individuals cutting themselves when fitting. Importantly, the inlet module 24 includes an end bead 24a within a outer bead 25 forming a first end bead or connection, and the inlet end of the filter housing 20b includes a similar bead 20b within an encompassing bead 27. These beads encompass a flow sleeve 46 providing a single or mono directional exhaust flowing device whereby the inlet module 24 can only be connected to the filter housing 20a in one direction. The inlet clamp 12 discussed above securely holds these beads together. Additionally, a gasket 12b can be provided to ensure a tighter and leak proof joint.

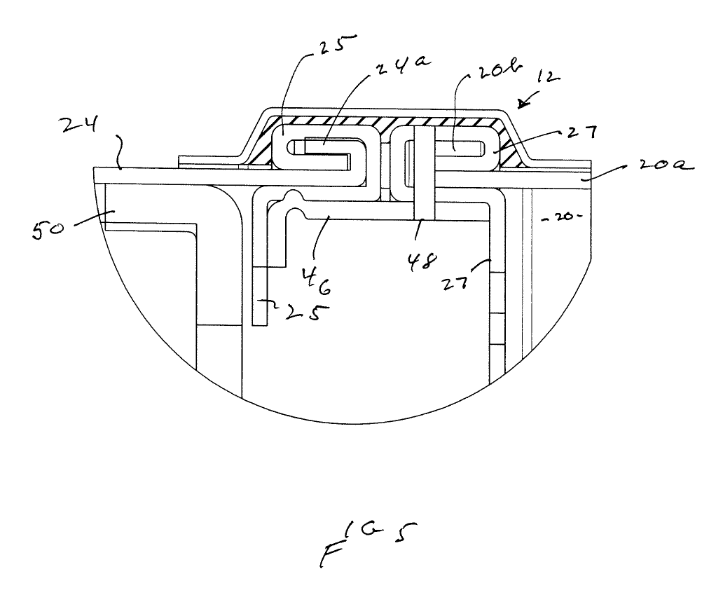

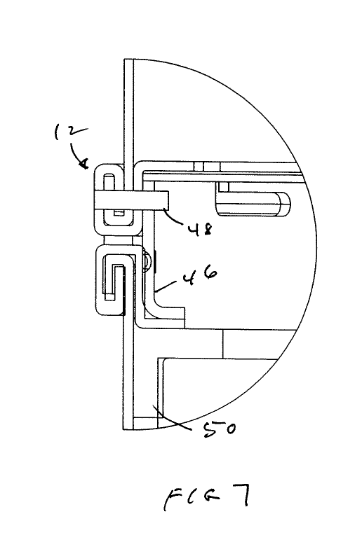

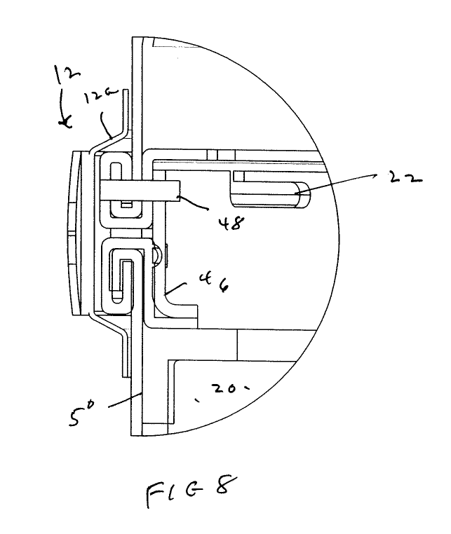

The flow sleeve 46 is provided within the mechanical joint and connection as seen in FIGS. 4-8 and which is keyed by a pin 48 for a bayonet connection. The pin 48 ensures proper placement and securing of the inlet module. The flow sleeve 46 minimizes the risk of any leak and provides the ability of making the filter a mono-directional unit thus ensuring that operators cannot avoid maintenance by just turning the filter 20 around and blowing the ash back out into the environment. The other end of the filter housing 20a and the outlet module 26 have like beads to similarly provide a tight or leakproof joint, although a flow sleeve is not used in that end.

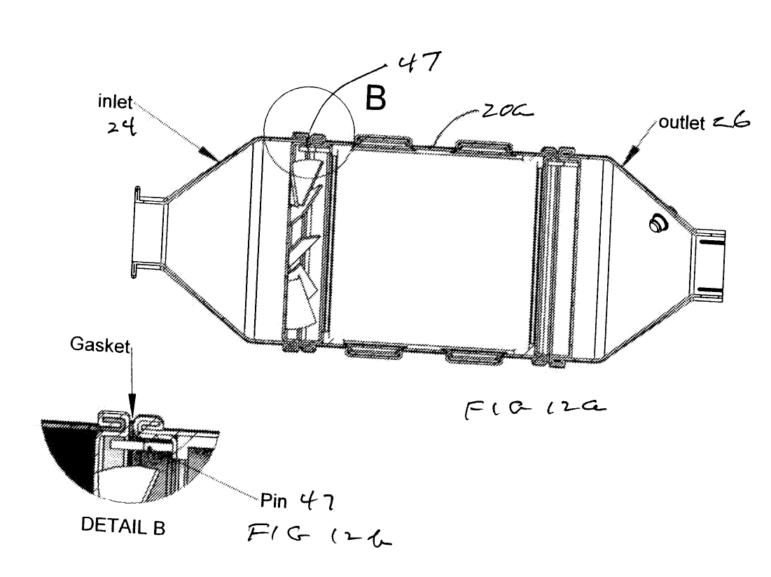

Alternative to the use of the flow sleeve 46, a horizontal longitudinal pin 47 as seen in FIGS. 12a-12b can be disposed between the inlet module 24 and the inlet of the filter module 20a to likewise prevent the filter from being installed backward.

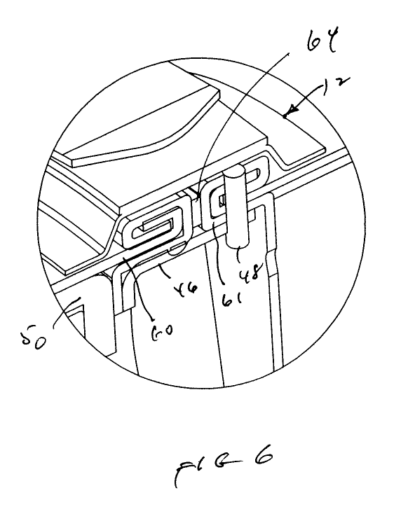

Further details of the end bead joints are illustrated in FIGS. 6 through 8. An L-seal 50—at the face of the filter 20 can be an additional axial support and reduces the risk of degradation of the mating.

FIGS. 4-8 illustrate more details of the clamp 12 showing mechanical end connections 60 and 61, the locking and locating pin 48 which locks the flow sleeve 46 in place. A sealing gasket 64 may be provided, and a further gasket (not shown) can be disposed around the end connections 60-61.

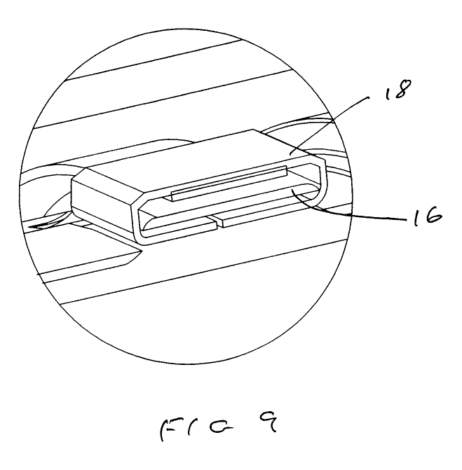

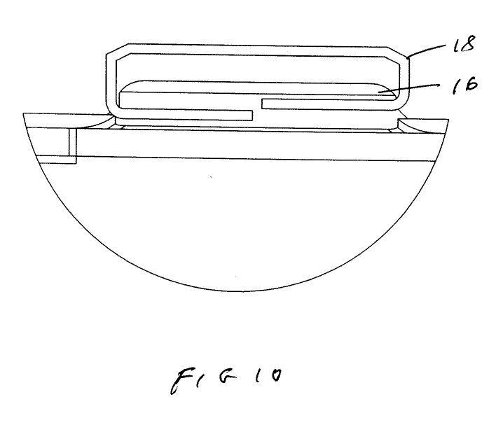

FIGS. 9 and 10 illustrate further details of the locators 18 and straps 16 around the filter body. The locators 18 can double as a wiring harness, support or heat shield mount if desired. They ensure correct fixture location for reducing vibration, wear and misalignment of the modules.

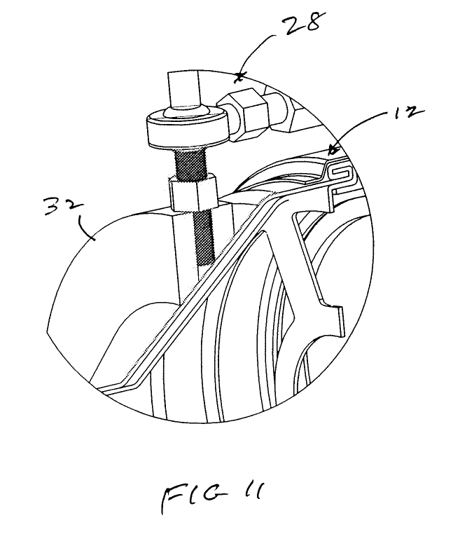

FIG. 11 shows further details of the tie bar 28 and slip ring 32 components of an optional mounting system.

While an embodiment of the present invention as been shown and described, various modifications may be made without departing from the scope of the present invention, and all such modifications and equivalents are intended to be covered.

What is claimed is:

1. An emission control device including a filter module connected between an inlet module and an outlet module
the ends of the filter module and mating ends of the inlet and outlet modules include end beads forming connections between these modules,
removable clamps securing the end beads of the inlet and outlet modules to the end beads of the filter module, and
a flow sleeve disposed between the inlet module and the filter module and secured therein to ensure one way flow placement of the inlet module to the filter module.

2. A device as in claim 1 further including an L-shaped seal at the inlet end of the filter to provide additional axial support for a filter within the filter module and improve the mating between the inlet module and the filter module.

3. A device as in claim 1 further including straps surrounding the filter module and positioned within locater members.

4. A device as in claim 1 wherein the removable clamps include a coded sleeve for indicating at what stage of maintenance the emission control device is in.

5. A device as in claim 4 wherein the sleeve is color coded.

6. An emission control device including a filter module connected between inlet and outlet modules; and
removable clamps securing the ends of the inlet and outlet modules to the filter module, and
each clamp including a sleeve for indicating what stage maintenance of the control device is in and which is replaced with a different indicator sleeve whenever filter maintenance is done.

7. A device as in claim 6 wherein the clamps each include a stripping nut to prevent reuse after maintenance.
